(19) United States
(12) Patent Application Publication
(10) Pub. No.: US 2024/0005208 A1
(43) Pub. Date: Jan. 4, 2024

(54) CONFLICT ANALYSIS SYSTEM

(71) Applicant: Bouncebounce, Ltd., Seoul (KR)

(72) Inventor: Jung Hye CHO, Seoul (KR)

(73) Assignee: Bouncebounce, Ltd., Seoul (KR)

(21) Appl. No.: 18/217,174

(22) Filed: Jun. 30, 2023

(30) Foreign Application Priority Data
Jul. 1, 2022 (KR) 10-2022-0081359

(51) Int. Cl. G06N 20/00

(52) U.S. Cl. CPC G06N 20/00

(57) ABSTRACT

A conflict analysis system includes an input providing unit and an analysis unit. The input providing unit provides input data information. The analysis unit analyzes input data, separates the input data into a plurality of pieces of analysis dimension information, and provides an analysis grade corresponding to each of the pieces of analysis dimension information. The conflict analysis system analyzes the cause of a social conflict through an artificial intelligence unit trained with big data related to social conflicts and multidimensional input data information separated into social, factual, and temporal dimensions, and provides an optimal conflict resolution solution.

### BACKGROUND OF THE INVENTION

### Field of the Invention

The present invention relates to a conflict analysis system.

### Description of the Related Art

As society becomes more complex, conflicts between members constituting society due to various interests are also increasing. Recently, various attempts have been made to analyze the causes of such conflicts between social members and to provide optimal solutions for conflicts.

### CITED REFERENCE

### Patent Document

(Patent Document 1) KR 10-1935330 (Dec. 28, 2018)

### SUMMARY OF THE INVENTION

An object of the present invention relates to multidimensional semantic analysis divided into the social dimension, the factual dimension, and the temporal dimension and is to provide a conflict analysis system that analyzes the cause of a social conflict through artificial intelligence trained with input data information and big data related to the social conflict and provides an optimal conflict resolution solution according to the purpose or orientation. Here, multidimensional semantic analysis may include not only natural language processing such as human emotion, age, personality, time and place, but also meaning interpreted in various dimensions. The artificial intelligence according to the present invention can automatically classify and analyze big data related to social conflicts.

In accordance with the present invention, the above and other objects can be accomplished by the provision of a conflict analysis system including an input providing unit and an analysis unit. The input providing unit may provide input data information. The analysis unit may analyze the input data information, separate the input data information into a plurality of pieces of analysis dimension information, and provide an analysis grade corresponding to each of the plurality of pieces of analysis dimension information.

In an embodiment, the analysis unit may further include an artificial intelligence unit generated by learning big data related to social conflicts occurring through social phenomena.

In an embodiment, the analysis unit may further include a dimension separator configured to separate the plurality of pieces of analysis dimension information.

In an embodiment, the dimension separator may include a first separator, a second separator, and a third separator. The first separator may provide social dimension information corresponding to information related to sense of ethics of an information provider among the input data information. The second separator may provide factual dimension information corresponding to information related to a cause of (generation of) a conflict between information providers among the input data information. The third separator may provide temporal dimension information corresponding to information related to the timing of a process in which the cause of the conflict is defined or change in perception of the information provider over time among the input data information.

In an embodiment, the conflict analysis system may further include a first analyzer, a second analyzer, and a third analyzer configured to analyze the social dimension information, the factual dimension information, and the temporal dimension information, classify the social dimension information, the factual dimension information, and the temporal dimension information into a plurality of categories, and provide analysis grades, respectively.

In an embodiment, the conflict analysis system may further include a weighting unit. The weighting unit may include a first weighting unit and a second weighting unit. The first weighting unit may provide global weights corresponding to weights applied to the plurality of pieces of analysis dimension information. The second weighting unit may provide fine weights corresponding to weights differently applied to the plurality of categories.

In an embodiment, the global weights may be determined depending on the analysis grade calculated for each of the plurality of pieces of analysis dimension information. The fine weights may be determined depending on the analysis grades of the plurality of categories included in each of the first to third separators.

In an embodiment, the conflict analysis system may further include a controller configured to selectively turn on the first weighting unit and the second weighting unit according to an operation mode.

In an embodiment, the conflict analysis system may further include a grade providing unit and a solution providing unit. The grade providing unit may provide a weighted grade obtained by applying the global weights and the fine weights to the analysis grades. The solution providing unit may provide a conflict resolution solution corresponding to the weighted grade.

In an embodiment, the conflict analysis system may further include a feedback unit. The feedback unit may feed response data information of the information provider for the conflict resolution solution back to the input providing unit.

In addition to the aforementioned technical task of the present invention, other features and advantages of the present invention will be described below, or will be clearly understood by those skilled in the art from such description.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram illustrating a conflict analysis system according to embodiments of the present invention;

FIG. 2 is a diagram illustrating an example of an analysis unit included in the conflict analysis system of FIG. 1;

FIG. 3 is a diagram illustrating an example of a dimension separator included in the analysis unit of FIG. 2;

FIG. 4 is a diagram for describing the operation of the dimension separator included in the analysis unit of FIG. 2;

FIG. 5 is a diagram illustrating an example of analyzers included in the analysis unit of FIG. 2;

FIG. 6 is a diagram for describing the operations of the analyzers included in the analysis unit of FIG. 2;

FIG. 7 is a diagram for describing an embodiment of the conflict analysis system of FIG. 1;

FIG. 8 is a diagram illustrating an example of a weighting unit included in the conflict analysis system of FIG. 7; and

FIG. 9 is a diagram for describing another embodiment of the conflict analysis system of FIG. 1.

### DETAILED DESCRIPTION OF THE INVENTION

In this specification, it should be noted that, in adding reference numerals to components of each drawing, the same components have the same reference numerals as much as possible even if they are displayed on different drawings.

Meanwhile, the meaning of terms described in this specification should be understood as follows.

Singular expressions should be understood as including plural expressions, unless the context clearly defines otherwise, and the scope of rights should not be limited by these terms.

It should be understood that terms such as “comprise” and “include” do not preclude the presence or addition of one or more other features, numbers, steps, operations, components, parts, or combinations thereof.

In a communication process, each recognition system that interprets homophones can be described through the example below. Example 1) “Boundary of family”: The boundary of family may include all family members, paternal and maternal grandparent kinship, parents and children, and parents, children and pets. Example 2) Regional development: Political meaning in administration. Local residents may mean safety and happiness, and expert groups may be interpreted in various manners in terms of economy.

Hereinafter, preferred embodiments of the present invention devised to solve the above problems will be described in detail with reference to the accompanying drawings.

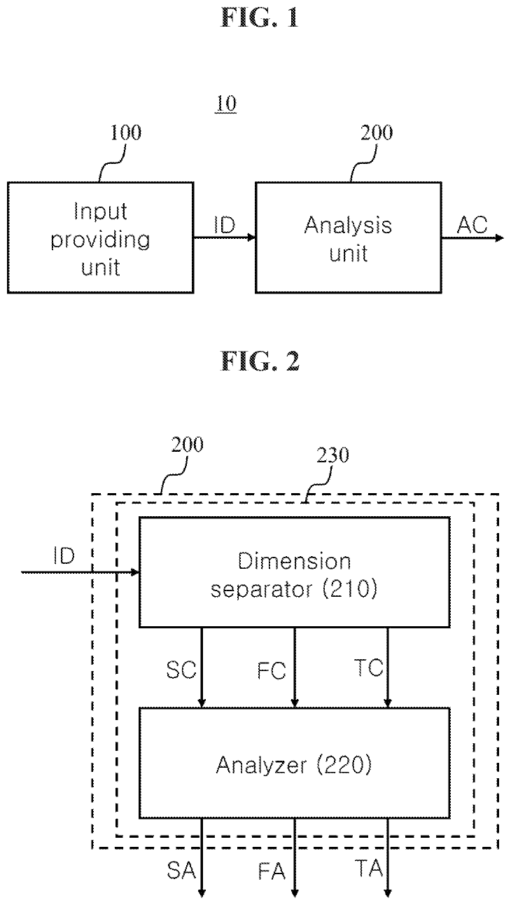

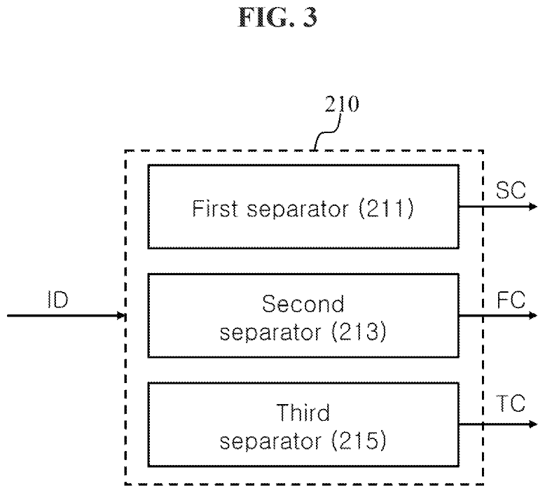

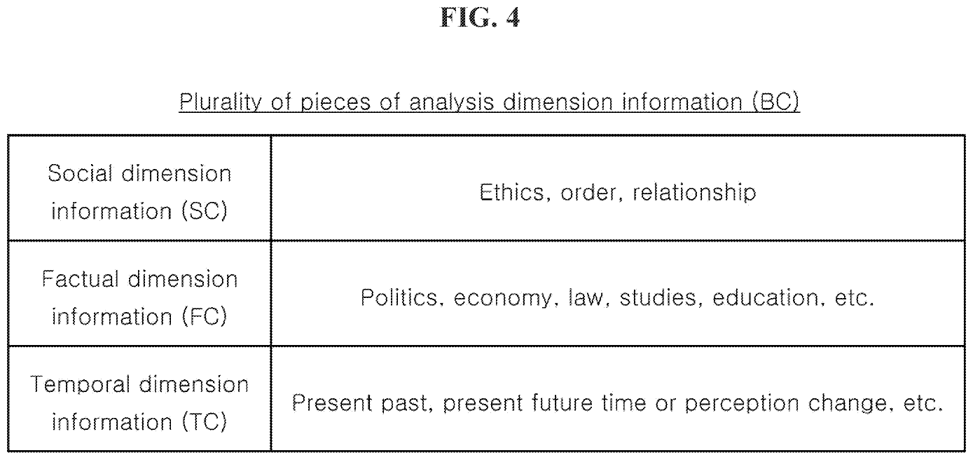

FIG. 1 is a diagram illustrating a conflict analysis system according to embodiments of the present invention, FIG. 2 is a diagram illustrating an example of an analysis unit included in the conflict analysis system of FIG. 1, FIG. 3 is a diagram illustrating an example of a dimension separator included in the analysis unit of FIG. 3, and FIG. 4 is a diagram for describing the operation of the dimension separator included in the analysis unit of FIG. 3.

Referring to FIGS. 1 to 4, the conflict analysis system 10 according to an embodiment of the present invention may include an input providing unit 100 and an analysis unit 200. The input providing unit 100 may provide input data information ID. For example, an information provider may be a subject who faces a conflict situation in the course of daily life, and the input data information ID may include all audio, text, and video data related to the conflict situation of the information provider.

The analysis unit 200 may analyze the input data information ID, separate the input data information ID into a plurality of pieces of analysis dimension information BC, and provide an analysis grade AC corresponding to each piece of the analysis dimension information. In one embodiment, the analysis unit 200 may further include an artificial intelligence unit 230 generated by learning big data related to social conflicts occurring through social phenomena. For example, the artificial intelligence unit may perform learning using input data information ID of past information providers who have faced conflict situations as training data. After deep learning the training data, the artificial intelligence unit may provide an optimal conflict resolution solution SL when the input data information ID is provided to the artificial intelligence unit 230 included in the analysis unit 200.

The analysis unit 200 may further include a dimension separator 210 for separating the plurality of pieces of analysis dimension information BC. In one embodiment, the dimension separator 210 may include a first separator 211, a second separator 213, and a third separator 215. The first separator 211 may provide social dimension information SC corresponding to information related to the sense of ethics of an information provider among the input data information ID. The second separator 213 may provide factual dimension information FC corresponding to information related to the cause of a conflict of the information provider among the input data information ID. The third separator 215 may provide temporal dimension information TC corresponding to information related to change in perception of the cause of the conflict of the information provider over time among the input data information ID.

For example, the input data information ID of the information provider currently in a conflict may be “XX, currently, the cost per household for reconstruction of our apartment is too high, so I oppose going forward with reconstruction unless the cost per household is reduced.” In this case, the first separator 211 may provide the profanity “XX” corresponding to information related to ethics, society, relationships, and profanity among the input data information ID as social dimension information SC, and the second separator 213 may provide “reconstruction costs” corresponding to information related to the economy, laws and institutions as factual dimension information FC. In addition, the third separator 215 may provide “I oppose going forward with reconstruction unless the cost is reduced” corresponding to information related to past, present, and future perception changes as temporal dimension information TC.

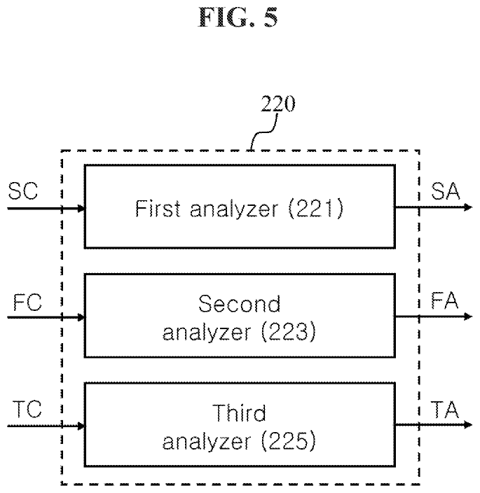

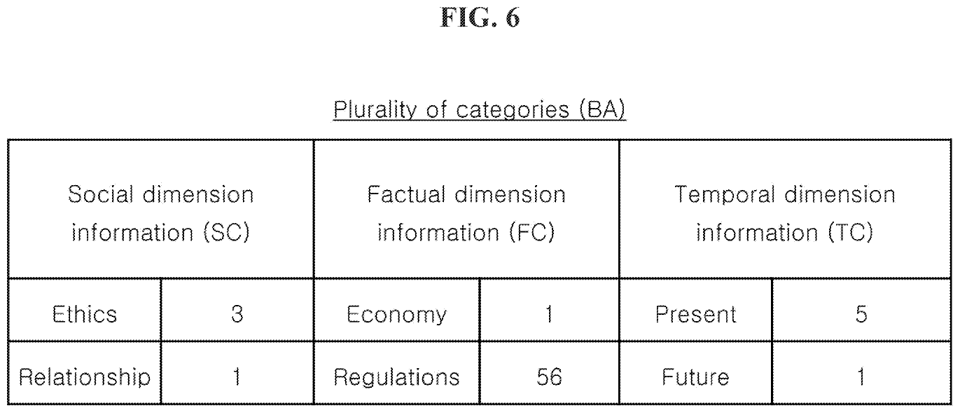

FIG. 5 is a diagram illustrating an example of analyzers included in the analysis unit of FIG. 2, and FIG. 6 is a diagram for describing the operations of the analyzers included in the analysis unit of FIG. 2.

Referring to FIGS. 1 to 6, in one embodiment, the conflict analysis system 10 may further include a first analyzer 221, a second analyzer 223, and a third analyzer 225 that respectively analyze social dimension information SC, factual dimension information FC, and temporal dimension information TC, classify the same into a plurality of categories, and provide analysis grades AC.

For example, the first separator 211 may provide social dimension information SC to the first analyzer 221. The first analyzer 221 may analyze the social dimension information SC and classify the same into a plurality of categories SA, and the plurality of categories may include an ethics category and a relationship category. In the ethics category, an ethical grade of an information provider may be indicated according to the social dimension information SC of the information provider, and in the relationship category, a social system relationship grade of the information provider may be indicated according to the social dimension information SC of the information provider. The ethical grade and the social system relationship grade may be stored in the conflict analysis system 10 in the form of a lookup table. Here, the grade of the ethics category of the information provider may be 3, and the grade of the relationship category may be 1.

For example, the second separator 213 may provide factual dimension information FC to the second analyzer 223. The second analyzer 223 may analyze the factual dimension information FC and classify the same into a plurality of categories FA, and the plurality of categories may include an economic category and a legal category. Here, the grade of the information provider in terms of economy may be 1, and the grade in terms of regulations may be 5.

For example, the third separator 215 may provide temporal dimension information TC to the third analyzer 225. The third analyzer 225 may analyze the temporal dimension information TC and classify the same into a plurality of categories TA, and the plurality of categories may include a present category and a future category. Here, a grade of the information provider in terms of present-past may be 5, and a grade in terms of present-future may be 1. The above description of the first analyzer 221 may be applied to the second analyzer 223 and the third analyzer 225 in the same manner.

In the conflict analysis system 10 according to the present invention, the cause of a social conflict may be analyzed through the artificial intelligence unit trained with multidimensional input data information ID separated into social, factual and temporal dimensions and big data related to social conflicts, and an optimal conflict resolution solution SL may be provided.

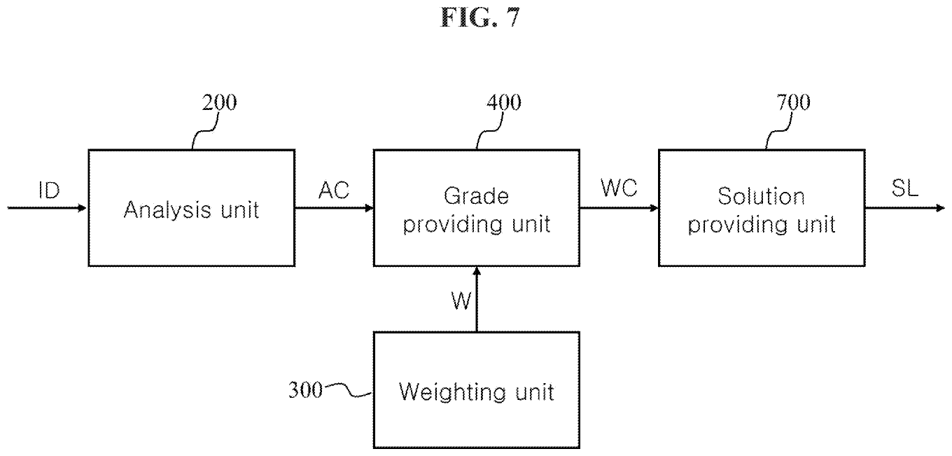

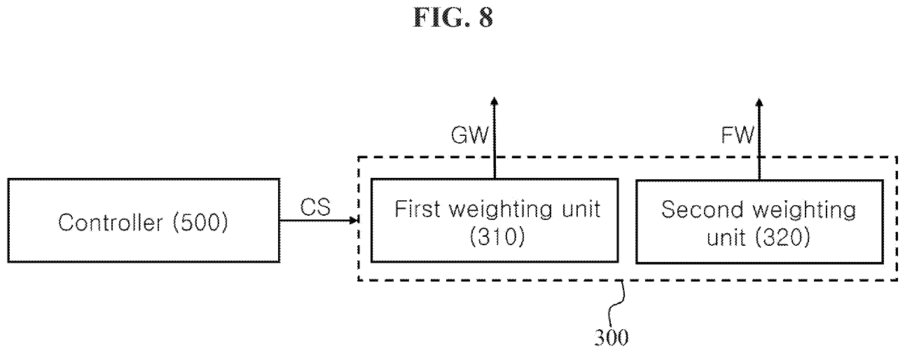

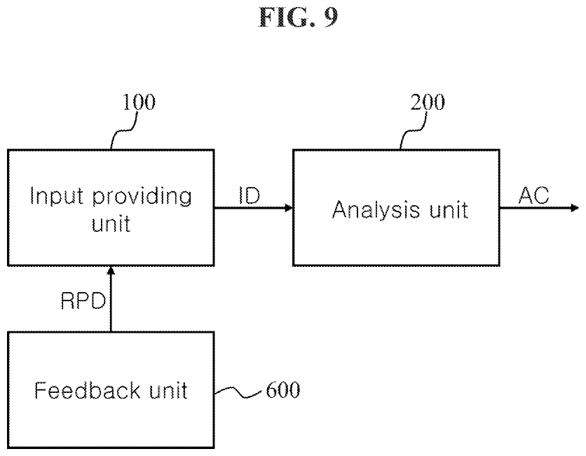

FIG. 7 is a diagram for describing an embodiment of the conflict analysis system of FIG. 1, FIG. 8 is a diagram illustrating an example of a weighting unit included in the conflict analysis system of FIG. 7, and FIG. 9 is a diagram for describing another embodiment of the conflict analysis system of FIG. 1.

Referring to FIGS. 1 to 9, in one embodiment, the conflict analysis system 10 may include a weighting unit 300. The weighting unit 300 may include a first weighting unit 310 and a second weighting unit 320. The first weighting unit 310 may provide a global weight GW corresponding to a weight applied to each of the plurality of pieces of analysis dimension information BC. For example, the global weight GW may include a first global weight GW1, a second global weight GW2, and a third global weight GW3. A global weight GW equally applied to the ethical category and the relationship category included in the social dimension information SC may be the first global weight GW1, and a global weight GW equally applied to the economic category and the legal category may be the second global weight GW2. In addition, a global weight GW equally applied to a present-past category and a present-future category included in the temporal dimension information TC may be the third global weight GW3. Here, the social dimension information SC may be information that can identify the social and ethical propensity of the information provider, the factual dimension information FC may be information on realistic problems necessary for the information provider to resolve a conflict, and the temporal dimension Information TC may be information that can be used to predict future changes in perception from the point of view of the information provider.

The second weighting unit 320 may provide fine weights FW corresponding to weights differently applied to a plurality of categories. For example, it may be necessary to assign different weights to the grade of the ethics category and the grade of the relationship category. In this case, fine weights FW may be applied. In this case, a fine weight FW applied to the ethical category may be a first fine weight FW1, and a fine weight FW applied to the relationship category may be a second fine weight FW2. The same may apply to the economic category, legal category, present category, and future category.

In an embodiment, the global weight GW may be determined depending on an analysis grade AC calculated for each piece of analysis dimension information BC. For example, an analysis grade AC calculated with respect to the social dimension information SC may include 3 in the case of the ethics category and 1 in the case of the relationship category. In this case, the analysis grade AC calculated with respect to the social dimension information SC may be 4 that is the sum of grade 3 for the ethics category and grade 1 for the relationship category. In the same manner, an analysis grade AC calculated with respect to the factual dimension information FC may be 6, and an analysis grade AC calculated with respect to the temporal dimension information TC may be 6. Here, the first global weight GW1 may be 4 that is the sum of 2 corresponding to the difference between the analysis grade AC calculated with respect to the social dimension information SC and the analysis grade AC calculated with respect to the factual dimension information FC and 2 corresponding to the difference between the analysis grade AC calculated with respect to the social dimension information SC and the analysis grade AC calculated with respect to the temporal dimension information TC. The same method may be applied at the time of calculating the second global weight GW2 and the third global weight GW3.

The fine weight FW may be determined depending on analysis grades AC of a plurality of categories included in each of the first separator 211 to the third separator 215. For example, the grade of the ethics category may be 3, and the grade of the relation category may be 1. In this case, if the grades of the categories are applied as they are to the fine weight FW, the first fine weight FW1 may be 3 and the second fine weight FW2 may be 1.

In one embodiment, the conflict analysis system 10 may further include a controller 500 that selectively turns on the first weighting unit 310 and the second weighting unit 320 according to an operation mode. For example, in a case where a user of the conflict analysis system 10 according to the present invention wants to use only the first weighting unit 310, the controller 500 may provide a first control signal CS1 to the weighting unit to turn on the first weighting unit 310 and turn off the second weighting unit 320, and in a case where the user of the conflict analysis system 10 according to the present invention wants to use only the second weighting unit 320, the controller 500 may provide a second control signal CS2 to the weighting unit to turn off the first weighting unit 310 and turn on the second weighting unit 320.

In one embodiment, the conflict analysis system 10 may further include a grade providing unit 400 and a solution providing unit 700. The grade providing unit 400 may provide a weighted grade WC obtained by applying the global weight GW and the fine weight FW to an analysis grade AC. In this case, the solution providing unit 700 may provide a corresponding conflict resolution solution SL according to the weighted grade WC. The conflict resolution solution SL for each weighted grade WC may be included in the conflict analysis system 10 in the form of a lookup table.

In one embodiment, the conflict analysis system 10 may further include a feedback unit 600. The feedback unit 600 may feed response data information RPD of the information provider for a conflict resolution solution SL back to the input providing unit 100. For example, if the conflict of the information provider is not resolved even through the conflict resolution solution SL provided from the conflict analysis system 10, the response data information RPD of the information provider for the conflict resolution solution SL may be re-used as input data information ID and transmitted to the input providing unit 100. In this case, the conflict analysis system 10 according to the present invention may provide a new conflict resolution solution SL.

The conflict analysis system 10 according to the present invention can analyze the cause of a social conflict through an artificial intelligence unit trained with multidimensional input data information ID separated into social, factual and temporal dimensions and big data related to social conflicts and provide an optimal conflict resolution solution SL.

According to the present invention as described above, the following effects are obtained.

The conflict analysis system according to the present invention can analyze the cause of a social conflict through artificial intelligence trained with multidimensional input data information divided into social dimension, factual dimension, and temporal dimension and big data related to social conflicts, and provide an optimal conflict resolution solution.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A conflict analysis system comprising:
an input providing unit configured to provide input data information; and
an analysis unit configured to analyze the input data information, separate the input data information into a plurality of pieces of analysis dimension information, and provide an analysis grade corresponding to each of the plurality of pieces of analysis dimension information.

2. The conflict analysis system of claim 1, wherein the analysis unit further comprises an artificial intelligence unit generated by learning big data related to social conflicts occurring through social phenomena.

3. The conflict analysis system of claim 2, wherein the analysis unit further comprises a dimension separator configured to separate the plurality of pieces of analysis dimension information.

4. The conflict analysis system of claim 3, wherein the dimension separator comprises:
a first separator configured to provide social dimension information corresponding to information related to sense of ethics of an information provider among the input data information;
a second separator configured to provide factual dimension information corresponding to information related to a cause of a conflict of the information provider among the input data information; and
a third separator configured to provide temporal dimension information corresponding to information related to change in perception of the cause of the conflict of the information provider over time among the input data information.

5. The conflict analysis system of claim 4, further comprising a first analyzer, a second analyzer, and a third analyzer configured to analyze the social dimension information, the factual dimension information, and the temporal dimension information, classify the social dimension information, the factual dimension information, and the temporal dimension information into a plurality of categories, and provide analysis grades, respectively.

6. The conflict analysis system of claim 5, further comprising:
a first weighting unit configured to provide global weights corresponding to weights applied to the plurality of pieces of analysis dimension information; and
a second weighting unit configured to provide fine weights corresponding to weights differently applied to the plurality of categories.

7. The conflict analysis system of claim 6, wherein the global weights are determined depending on the analysis grade calculated for each of the plurality of pieces of analysis dimension information, and the fine weights are determined depending on the analysis grades of the plurality of categories included in each of the first to third separators.

8. The conflict analysis system of claim 7, further comprising a controller configured to selectively turn on the first weighting unit and the second weighting unit according to an operation mode.

9. The conflict analysis system of claim 8, further comprising:
a grade providing unit configured to provide a weighted grade obtained by applying the global weights and the fine weights to the analysis grades; and
a solution providing unit configured to provide a conflict resolution solution corresponding to the weighted grade.

10. The conflict analysis system of claim 9, further comprising a feedback unit configured to feed response data information of the information provider for the conflict resolution solution back to the input providing unit.
